(19) United States
(12) Patent Application Publication
(10) Pub. No.: US 2011/0200711 A1
(43) Pub. Date: Aug. 18, 2011

(54) COMPACTED FOOD FOR ANIMALS

(76) Inventor: Jose Munoz Leo, Malpica de Tajo (Toledo) (ES)

(21) Appl. No.: 12/733,218

(22) PCT Filed: Aug. 11, 2008
(86) PCT No.: PCT/ES2008/070160

§ 371 Date: Apr. 18, 2011

(30) Foreign Application Priority Data
Aug. 14, 2007 (ES) P200702279

(51) Int. Cl. A23K 1/00

(52) U.S. Cl. 426/61; 426/635; 426/71; 426/106

(57) ABSTRACT

The compacted food for animals is made up of the following elements: a) essential oils; b) molasses; c) correctives; d) forage; e) water; f) aromas; g) glucoses; mixed, minced and compacted.

### OBJECT OF THE INVENTION

This invention refers to complete and balanced compacted food for animals presenting optimal conservation qualities and a compacted food pack.

### BACKGROUNDS OF THE INVENTION

At present there is a large variety of foodstuffs for animals, based on mixtures of forage with other substances to improve their nutritional qualities.

However, it is often these foodstuffs do not achieve an optimal energy and nutritional balance, as some nutrient substances go off quickly in presence of air. For this reason, these nutrient substances, that would be very healthy for animals, are frequently eliminated from foodstuffs for animals.

Another problem consists in the proliferation of fungi and bacteria that may occur in the presence of air, which can cause illnesses to animals.

### DESCRIPTION OF THE INVENTION

The foodstuff of this invention has an optimal make-up that corrects the disadvantages described above.

Indeed, the food of the invention turns out to be balanced regarding nutrients and energy, thus being very healthy for animals.

Likewise, on order to preserve the quality of the food, the invention foresees its vacuum conservation in special packages that generally offer a smaller size and a lower weight.

In accordance with the invention, the food includes:
essential and unsaturated oils
molasses, preferably from sugar cane and/or beetroot
correctives
forage
water
aromas
glucose
   appropriately mixed, minced and compacted, achieving grain sizes ranging from 1 mm to natural size. The food may be compacted in such a way it forms a cubic or a prismatic rectangular shape.

The forage includes cereals that may be extruded, precooked, swollen, probiotic and/or prebiotic.

Similarly, the invention also foresees vacuum conservation of the food and away from the light, ideally in packages containing a full helping in such a way there are no leftovers or food remains that may go bad, so as to make full use of same.

In this sense, the invention also includes as its object a compacted food pack including the compacted food and an opaque plastic, airproof, vacuum wrapping around the compacted food.

Vacuum wrapping leads to compacting and to a maximum reduction in the volume and weight of the food, reducing transport, handling and storage expenses, while achieving low weight and volume packs or packages.

### DESCRIPTION OF A PRACTICAL EXECUTION OF THE INVENTION

The food of the invention includes at least:
essential and unsaturated oils
molasses
correctives
forage
water
aromas
glucose

These components are conveniently mixed and minced, with grain sizes going from 1 mm to the natural size.

The forage includes cereals that may be extruded, precooked, swollen, probiotic and/or prebiotic.

This make-up corresponds to a foodstuff with the aroma and appearance of fresh forage out of natural products, with nutrient and energy balance.

Vacuum conservation is required for the foodstuff to preserve its properties. For this, the invention has envisaged a compacted food pack including the compacted food and an opaque plastic and airproof wrapping, of adequate resistance and fully thermowelded around the compacted food, arranged over an appropriate foodstuff volume and performed under vacuum conditions. The proliferation of fungi and bacteria is avoided in this way. Furthermore, the vacuum conditions achieve maximum compacting and, therefore, minimum weight and volume.

The envelope is free from steel strips or other mechanical or consistent elements that may damage the compacted food and remove the vacuum conditions, with the resistance of the plastic used being enough to withstand its direct handling or manipulation under normal conditions.

In order to optimise storage and transport, the invention foresees the pack will preferably take on a cubic or prismatic rectangular shape, containing inside an amount of the product equivalent to a full helping, with approximate dimensions of 60×50×40 cm and an approximate weight of 30-35 kg.

1. Compacted food for animals, featured because it have, at least: a) essential oils; b) molasses; c) correctives; d) forage; e) water; f) aromas;
g) glucoses; mixed, minced and compacted.

2. Compacted food for animals according to claim 1 characterised by the fact the molasses include sugar cane and/or beetroot molasses.

3. Compacted food for animals according to claim 1 characterised by the fact the forage includes extruded, precooked, swollen, probiotic and/or prebiotic cereals.

4. Compacted food for animals according to claim 1 characterised by the fact it has a grain size of 1 mm onwards.

5. Compacted food for animals according to any of the previous claims characterised by the fact it has a cubic shape.

6. Compacted food for animals according to any of the previous claims characterised by the fact it has a prismatic rectangular shape.

7. Compacted food pack characterised by the fact it includes:
the compacted food described in any of claims 1 to 6, and
an opaque plastic envelope, airproof and resistant, fully thermowelded vacuum seal around the compacted food.

8. Compacted food for animals according to claim 7 characterised by the fact it presents dimensions of 60×50×40 cm and a weight of the compacted food ranging from 30 to 35 kg.
